(19) United States
(12) Patent Application Publication
(10) Pub. No.: US 2018/0238419 A1
(43) Pub. Date: Aug. 23, 2018

(54) APPARATUS AND METHOD FOR WORKPIECE MACHINING ON A GEAR CUTTING MACHINE

(71) Applicant: Liebherr-Verzahntechnik GmbH, Kempten (DE)

(72) Inventor: Franz GLASER, Kempten (DE)

(21) Appl. No.: 15/900,629

(22) Filed: Feb. 20, 2018

(30) Foreign Application Priority Data
Feb. 21, 2017 (DE) 10 2017 001 652.6

(51) Int. Cl. F16F 15/36; B24B 41/00; B23F 23/12; B23Q 11/00; B23Q 3/12

(52) U.S. Cl. CPC F16F 15/36; B24B 41/007; B23Q 3/12; B23Q 11/0032; B23F 23/1237

(57) ABSTRACT

The present disclosure relates to an apparatus for use in a gear cutting machine for the gear-coupled manufacture or machining of workpieces having at least one machine table at which a workpiece spindle is arranged for holding a clamping apparatus for a workpiece, and having at least one tool spindle for holding a machining tool, wherein the tool spindle is equipped with an integrated balancing system for balancing the tool. In accordance with the present disclosure, a further independent balancing system for the workpiece spindle is integrated in addition to the balancing system in the tool spindle.

### CROSS REFERENCE TO RELATED APPLICATION

This application claims priority to German Patent Application No. 10 2017 001 652.6, entitled “Apparatus and Method for Workpiece Machining on a Gear Cutting Machine,” filed Feb. 21, 2017, the entire contents of which is hereby incorporated by reference in its entirety for all purposes.

### TECHNICAL FIELD

The present disclosure relates to an apparatus for hob honing, gear skiving, and generating grinding in the form of a gear cutting machine, the apparatus having at least one machine table at which a workpiece spindle is arranged for holding a clamping apparatus for a workpiece, and having at least one tool spindle for holding a machining tool, wherein the tool spindle is equipped with an integrated balancing system for balancing the tool; and to a method for balancing and operating the spindles in the gear cutting machine.

### BACKGROUND AND SUMMARY

Constantly increasing demands on the gear teeth require a constant improvement of the gear wheel quality. This quality improvement should be accompanied by a reduction of the manufacturing costs. Modern cutting materials and the desire for ever shorter machining times with toothed workpieces results in higher spindle speeds at the workpiece and at the tool. The higher spindle speeds can in particular be realized by the use of direct drives. The stock removal performance values can thereby also be considerably increased. However, the demands on the machines and on their static and dynamic properties thereby increase in turn.

In particular, in gear-coupled gear cutting processes in which the tool shape is mapped onto the workpiece by the manufacturing process, high demands are made on the synchronization of the rotary drives for the tool and the workpiece and on the axial drives for the linear axes that are involved in the gear cutting process. Errors in the axis movements and above all in the gear coupling immediately become noticeable as gear cutting errors and/or surface errors in the workpiece.

Machine tools, in particular grinding machines, having a fast-running tool spindle that should simultaneously generate high surface qualities have dynamic problems more frequently than other machines, said dynamic problems being able to result in an exceeding of the required surface roughness quality and shape maintenance quality of the machined workpieces. These dynamic problems arise due to the eigen modes and the eigen frequencies that are excited by the tool spindle. A balancing of the tool spindles typically improves the basic problem.

With machine tools having dressable tools, the balance quality of the tool can additionally vary with each dressing cycle due to influences from the dressing process based on changes of geometry or on a different coolant intake.

These machines are therefore as a rule provided with an integrated balancing system for balancing the tool spindle with the clamped tool to suppress vibration excitations by the tool in the machine and thus to improve the machining result. With grinding machines having wide tools, in particular gear cutting grinding machines having wide grinding worms, multilevel balancing systems are frequently used to balance the tool over its entire width.

Multilevel balancing systems for balancing a tool spindle have been described in different publications. EP 1 870 198 A thus, for example, describes a multilevel balancing system for balancing a grinding tool in which balance weights are radially displaced by means of small adjustment motors that are arranged within a balancing head in the tool spindle and thus improve the balance quality of the entire system of tool and tool spindle. The actuators are controlled via a controller that converts signals of a vibration measurement device (acceleration sensors), not shown, into control signals for the motors in order thus to minimize the vibration stimulation by the tool.

With current grinding processes, the speeds between the tool and workpiece differ considerably (in gear wheel machining e.g. in accordance with the transmission ratio between the tool and the workpiece). It has therefore to date been considered sufficient for only the tool spindle to be balanced since it is typically operated at much higher speeds and is thereby particularly sensitive to dynamic excitations that can result in eigen excitation of the spindle.

The demands for ever shorter machining times for the gears increasingly have the result that multi-start tools are used. At the same time, the demands on machining accuracy in the gears are increasing. This first has the result that the workpiece speed has to be adapted in relation to the number of starts at the same tool speed—due to the gear coupling. The required table speeds hereby also increase considerably. At the same time, this has the result that dynamic problems at the table spindle can now also come much more strongly to the fore and the machining result deteriorates overall.

It is therefore the object of the present disclosure also to improve an apparatus of the initially named kind such that even when multi-start machining tools are used at high spindle speeds at the tool and workpiece, the machining result of the workpieces machined thereby satisfies the required quality demands. The apparatus should be used in the form of a gear cutting machine, in particular for machining involute spur gears or also sections having a repeating structure that can be machined using a gear coupled process. Dressable tools may be used as the tools.

This object is satisfied by an apparatus for use in a gear cutting machine for a gear-coupled manufacture or machining of workpieces having at least one machine table at which a workpiece spindle is arranged for holding a clamping apparatus for a workpiece, and having at least one tool spindle for holding a machining tool, wherein the tool spindle is equipped with an integrated balancing system for balancing the tool, wherein a further independent balancing system for the workpiece spindle is integrated in addition to the balancing system in the tool spindle; by a method of balancing the apparatus for use in the gear cutting machine for the gear-coupled manufacture or machining of workpieces, wherein a balance quality of the tool spindle having the balancing system is optimized independently of the tool spindle having the balancing system, while the tool and the workpiece are not in engagement with one another; and by a gear cutting machine having the apparatus for the gear-coupled manufacture or machining of workpieces. Embodiments form the subjects of the dependent claims.

The present disclosure comprises an apparatus composed of at least one machine table for holding a clamping apparatus for a workpiece and of at least one tool spindle for holding a tool for manufacturing or machining gear teeth. The machining may take place using the gear-coupled gear cutting process, i.e. the quality of the gear coupling is co-decisive for the quality of the gearing produced. This means that errors in the climb method in one of the two spindles, for example vibrations at the tool spindle, are first mapped on the workpiece. This can then, however, also have the result that the other spindle, i.e. the workpiece spindle that is also called a table spindle, is likewise excited to vibrations. This can in turn result in further mutual amplification of the excitation that overall then has a negative effect on the gear cutting quality.

It was known in the prior art only to balance the more dynamic tool spindle. Multi-start tools, above all those with a high number of starts, now have the result that the workpiece spindles also have to be operated at a high speed in accordance with the transmission ratio between the tool and the workpiece. The solution of the present disclosure now comprises also equipping the spindle at the workpiece side with a balancing system to reduce the dynamic excitations in this spindle. This is above all so that the tool spindle and the workpiece spindle do not mutually excite themselves to vibrations due to the gear coupling and so negatively influence the machining result. For this purpose, the settings of the balancing heads can first be minimized by the machine controller, but are then also coordinated with one another.

Depending on the embodiment, the balancing unit can be integrated in the table spindle, the table plate or also in the clamping apparatus, with the respective arrangement being able to be selected in accordance with the construction space present. The table plate or the apparatus are in particular selected as the installation site when already existing machines are to be retrofitted with the apparatus without having to replace the total table spindle.

Corresponding to the design of the balancing system, at least one acceleration sensor has to be associated with each of the spindles so that the machine controller is able to associate the correspondingly received measured signals with a spindle. The corresponding correction signals for the balancing devices also have to be transmitted to the correct spindle and to the correct balancing unit. Their effect must finally be checked.

In multilevel balancing systems, at least two accelerometers per spindle are frequently installed to detect the different imbalance components. If even more sensors having different orientations are additionally installed on the spindle at the table spindle, both the radial components and the tangential components of the direction of effect can be observed separately and can optionally be directly influenced.

In the simplest embodiment, the balance quality is respectively optimized and minimized in both spindles separately and independently of one another. Depending on the transmission ratio, different balance quality stages can, however, also be predefined for the spindles so that the time duration for the balancing of the two spindles can be reduced. In machines having more than one workpiece spindle or tool spindle, the respective spindles are coordinated with one another that machine the current workpiece in the following machining while gear coupled to one another. If at least two tool spindles are provided in the machine, a spindle can be provided for holding the dressing tool.

In an embodiment of the method, the balance quality of the tool spindles are each optimized while taking account of the other spindle, with the tool and the workpiece initially not being in engagement with one another. In this embodiment of the method, the gear coupling is taken into account electronically; however, no mutual mechanical influencing of the spindles between one another takes place.

In a further embodiment of the method, the balance quality of the tool spindles are each optimized while taking account of the other spindle, with the tool and the workpiece initially not being in engagement with one another. In a second step, the tool and the workpiece are brought into engagement with one another and the balance quality of this coupled system is subsequently checked. If required, one or both spindles are rebalanced while taking account of the mutual mechanical influence.

In a further embodiment of the method, the acceleration sensors that serve the measurement of the vibration speed in dependence on the phase angle and from whose measurement result the respective correction factors for the spindle balancing system are calculated are associated with a spindle. The measurement system is either installed at the spindle that is also equipped with the associated balancing system or the measurement system is arranged at the respective other spindle, whereby the optimization can be performed while taking account of the mutual influencing.

In a further embodiment of the method, the balance quality of one of the two spindles is first optimized and for this purpose the respective other spindle is set in dependence on the first spindle while taking account of the phase size and phasing of the vibrations. The total system can be set by this optimization such that the remaining residual vibrations of the spindle systems complement or cancel one another. Using this optimization, specific surface properties can also be directly generated on the tooth flanks machined in this manner due to the direct generation of beats or cancellations between the spindle vibrations.

In a further method using differently radially arranged acceleration sensors, both the radial component and the tangential component of the direction of effect of the vibrations are evaluated, with in particular acceleration sensors at the workpiece spindle being able to be evaluated and with the results of these measurements being able to be directly converted by the controller into control signals that produce vibrations of the workpiece in the radial direction, the tangential direction, or another direction. Specific surface properties of the tooth flanks machined in this manner can hereby be generated in a targeted manner.

The present disclosure further relates to a gear cutting machine having an apparatus and having a control program for carrying out the method in accordance with the present disclosure.

Further features, advantages, and properties of the present disclosure will be explained in more detail in the following with reference to an embodiment shown in the drawing.

### BRIEF DESCRIPTION OF THE FIGURES

FIG. 1 shows the design of a gear grinding machine in accordance with the prior art in a schematic representation with its machine axes.

FIG. 2 shows a sectional view through an embodiment of the dressing tool in accordance with the present disclosure such as can be used in a gear grinding machine in accordance with FIG. 1.

### DETAILED DESCRIPTION

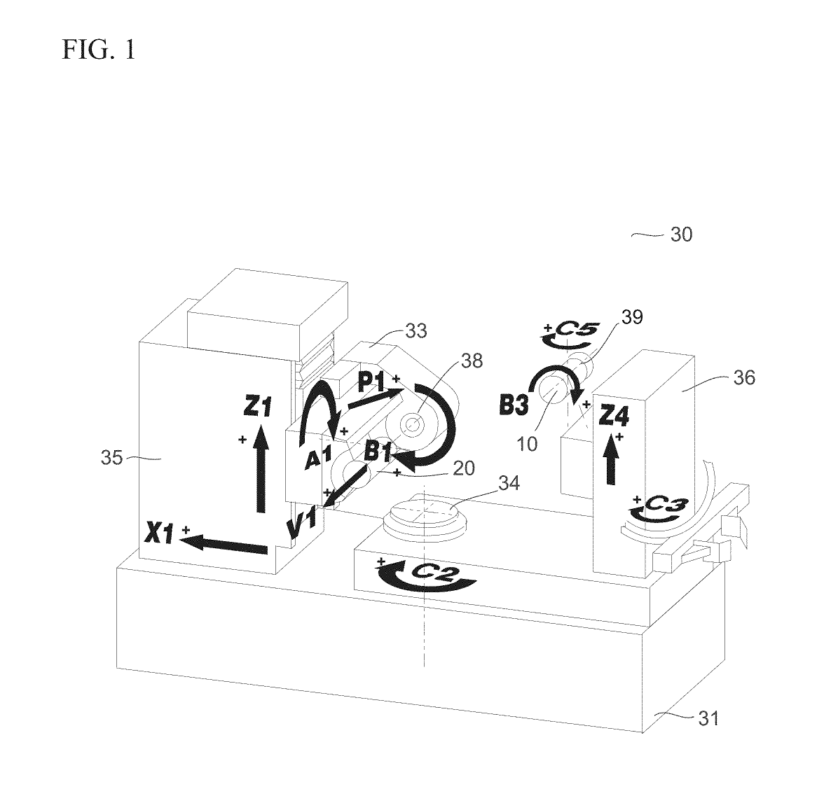

The design of a gear cutting machine 30, in this case a gear grinding machine, will be explained using the schematic representation of FIG. 1. It can be used for the use of the method in accordance with the present disclosure. The assemblies of machine column 35, counter column 36, and machine table 34 are arranged on a machine bed 31. The machine column 35 can move linearly along the X1 direction in the direction toward the machine table 34. A machining head 33 having the degrees of freedom A1, V1, P1 and Z1 is mounted at the machine column 35. The tool can be shifted relative to the workpiece via the V1 axis. A pivot movement takes place via the A1 axis. The Z1 axis serves to move the machining head 33 with the grinding tool 20 mounted in the B1 axis in parallel with the workpiece axis (C2) during the workpiece machining.

The grinding tool 20 can—in this embodiment—be moved toward the dressing tool 10 via machine movements along the X1 and Z1 axes so that the dressing process can take place there. The dressing tool 10 is received in the dresser 39 and rotates about the axis B3 during the dressing process. The dresser 39 can be pivoted about the C5 axis for correction movements of e.g. the engagement angle at the grinding tool. The grinding tool may be a grinding worm, for example. The movement of the grinding tool in the V1 direction delivers the relative movement between the grinding worm and the dressing tool 10, with the movement speed being predefined by the lead of the worm, its number of starts and the worm speed that has to be synchronized with the movement of the dressing tool 10. The counter column 36 can be pivoted about the C3 axis. The dresser 39 having the degree of freedom Z4 is mounted in the counter column. The Z4 axis serves to move the dresser 39.

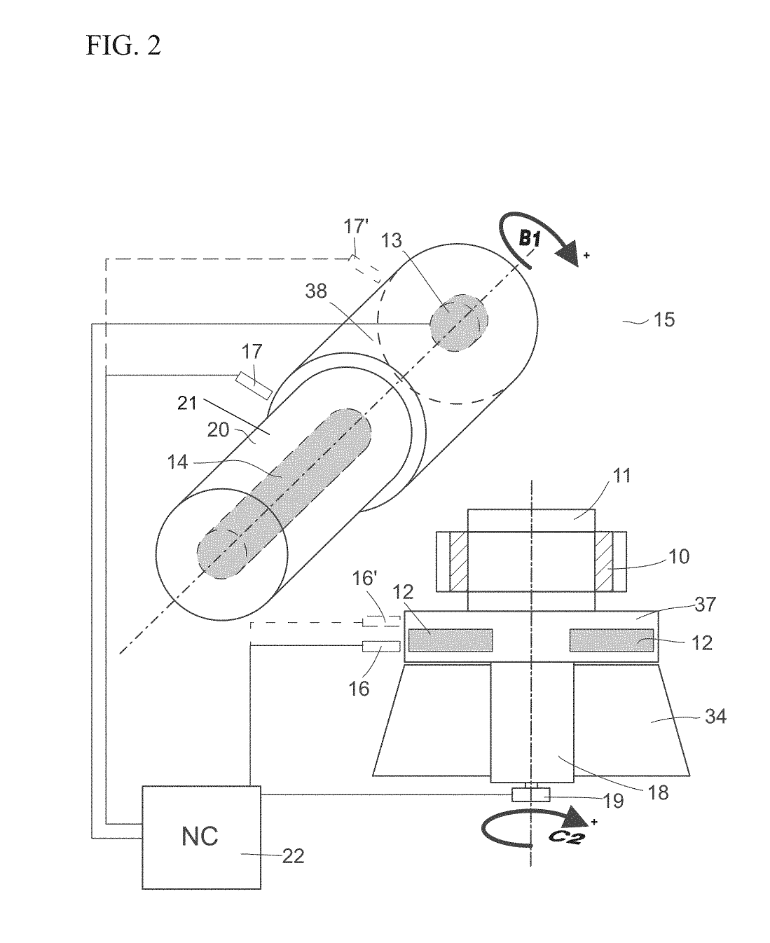

FIG. 2 schematically shows an exemplary embodiment of the apparatus 15 in accordance with the present disclosure for balancing the two machine components workpiece drive and tool drive with at least one balancing system each per spindle. The balancing system can have a respective one multilevel balancing head. A balancing system 12 is shown at the machine table 34 and is integrated in this embodiment in the table plate 37 for holding the workpiece clamping device 11 for the workpiece. Depending on the existing construction space, however, this balancing system 12 can also be integrated in the table spindle 18 or in the workpiece holder 11. The vibration of the table spindle 18 can be recorded by size and, in conjunction with a rotary encoder 19, its position of the angle of rotation (C2 axis) can also be recorded via one or more sensors 16, 16′. The measurement results are forwarded to the machine controller 22 that determines correction values therefrom.

At the tool side, the balancing system 14, which may be the multilevel balancing head, is integrated into a tool holder 21 of the grinding tool 20 for holding the machining tool, not shown. The tool holder 21 is driven via the tool spindle 38. One or more sensors 17, 17′ here likewise serve the recording of the spindle vibrations by size and by position of the angle of rotation in dependence on the rotation position of the spindle (B1 axis) for recording via a rotary encoder 13. The recorded values are then forwarded to the machine controller 22 for calculation.

1. An apparatus for use in a gear cutting machine for a gear-coupled manufacture or machining of workpieces having at least one machine table at which a workpiece spindle is arranged for holding a clamping apparatus for a workpiece, and having at least one tool spindle for holding a machining tool, wherein the tool spindle is equipped with an integrated balancing system for balancing the tool, wherein
a further independent balancing system for the workpiece spindle is integrated in addition to the balancing system in the tool spindle.

2. The apparatus in accordance with claim 1, wherein the balancing system at the machine table is integrated in the tool spindle or in a table plate or in the workpiece clamping apparatus.

3. The apparatus in accordance with claim 1, wherein the balancing systems are designed with at least one respective acceleration sensor per balancing system and per balancing plane.

4. The apparatus in accordance with claim 1, wherein the balancing systems are designed with a respective at least two acceleration sensors per balancing system, with the sensors being arranged radially and/or axially spaced apart with respect to the spindle and/or, on a presence of a plurality of sensors per spindle, they are arranged radially at different angles with respect to the spindle and/or additionally being differently axially spaced apart.

5. A method of balancing an apparatus for use in a gear cutting machine for a gear-coupled manufacture or machining of workpieces, having at least one machine table at which a workpiece spindle is arranged for holding a clamping apparatus, and having at least one tool spindle for holding a machining tool, wherein the tool spindle is equipped with an integrated balancing system, wherein a further independent balancing system for the workpiece spindle is integrated in addition to the balancing system in the tool spindle, wherein a balance quality of the tool spindle having the balancing system is optimized independently of the tool spindle having the balancing system, while the tool and the workpiece are not in engagement with one another.

6. The method in accordance with claim 5, wherein the balance quality of the tool spindle having the balancing system is optimized, synchronized with the workpiece spindle having the balancing system, while taking account of the respective other spindle, with the tool and the workpiece not being in engagement with one another.

7. The method in accordance with claim 5, wherein the balancing systems are first optimized in a first step without the tool and the workpiece being in engagement with one another, with the balance quality of the spindles being checked and optionally readjusted in a subsequent second step, while the tool and the workpiece are in engagement.

8. The method in accordance with claim 6, wherein the respective acceleration sensors belonging to the spindle are evaluated for setting the balancing heads; and/or in that the respective acceleration sensors belonging to the other spindle are evaluated for setting the balancing heads.

9. The method in accordance with claim 5, wherein first the balance quality of the tool spindle or of the workpiece spindle is optimized and the other spindle is subsequently set in dependence on the first spindle while taking account of a phase size and of phasing.

10. The method in accordance with claim 9, wherein a direct generation of vibration amplitudes having a specific phase size and phasing produces beats or cancellations of vibrations between the two spindles, whereby specific surface modifications are generated on a flank of the workpiece machined.

11. The method in accordance with claim 10, wherein the vibrations are imparted radially in a direction toward the tool and/or are imparted tangentially to the tool by a direct generation of vibrations at the workpiece spindle.

12. A gear cutting machine having an apparatus for a gear-coupled manufacture or machining of workpieces, having at least one machine table at which a workpiece spindle is arranged for holding a clamping apparatus, and having at least one tool spindle for holding a machining tool, wherein the tool spindle is equipped with an integrated balancing system, wherein a further independent balancing system for the workpiece spindle is integrated in addition to the balancing system in the tool spindle; and having a controller with instructions for carrying out a method of balancing the apparatus, wherein a balance quality of the tool spindle having the balancing system is optimized independently of the tool spindle having the balancing system, while the tool and the workpiece are not in engagement with one another.
